(19) United States
(12) Patent Application Publication
(10) Pub. No.: US 2006/0008094 A1
(43) Pub. Date: Jan. 12, 2006

(54) WIRELESS MULTI-CHANNEL AUDIO SYSTEM

(76) Inventors: Jui-Jung HUANG, Hsin-Chu Hsien (TW); Shih-Chieh Lo, Taichung County (TW); Chun-Pin KUO, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 10/907,559

(22) Filed: Apr. 5, 2005

(30) Foreign Application Priority Data
Jul. 6, 2004 (TW) 093120243

(51) Int. Cl. H04B 5/00; H04B 3/00

(52) U.S. Cl. 381/79; 381/2; 381/77

(57) ABSTRACT

A wireless multi-channel audio system includes a receiving unit, a decoder, a sound channel mixing and processing unit, and a plurality of earphone speakers. The audio system is equipped with a wireless transmitter of low signal delay time and high transmission data rate to send an SPDIF audio signal to an earphone or headphone having multiple speakers in real time and implement the multi-channel surround effect.

### BACKGROUND OF INVENTION

1. Field of the Invention

The present invention relates to an audio system, and more particularly to a wireless, multi-channel audio system.

2. Description of the Prior Art

Sounds are a fundamental way in which people communicate with others. Regardless, if it is voice or music, all are sent by sounds. As new technologies are developed progressively, sounds remain an important way for people to communicate or relax. Products such as audio systems are important products for people to enjoy music and relax. This is especially true of wireless audio systems. The most convenient way to transmit sounds is via air transmission. For instance, a wireless radio utilizes a wireless connection instead of a wired connection, and transmits and receives signals wirelessly. If a user wears a wireless headphone and stays within the wireless signal coverage, the user can hear audio through the wireless headphone. This makes it convenient for the user to move at will within the wireless signal coverage.

As stereo systems have developed, the user enjoys better surround effects. However, the surround effects of such a stereo coverage is limited due to the position of the user. If the user moves a little from the optimal reception area, the surround effects are enormously reduced. Therefore, manufacturers propose a system of 5.1 stereo channel to create better stereo surround effects. The system of 5.1 stereo channel has left/right channels, a center channel, left/right surround channels, and a low frequency effect channel. The system of 5.1 stereo channel includes digital theater system (DTS) and Dolby Digital 5.1, called audio code-3 (AC-3). The two systems are supported by Sony/Philips digital interface format (SPDIF), which is a standard interface for a digital audio system. Such a digital audio system can transmit signals formatted for Dolby or DTS and is also supported by DVD and home theater, transmitting 5.1 stereo channel signals through wired connections.

5.1 stereo channel includes six channels, two front channels, two rear channels, a center channel, and a low frequency effects channel and thereby six speakers, and six wires are needed to connect corresponding channels to an audio/video receiver (AVR), or to six analog output ports of a DVD player. Due to the complexity of the six connections, the user must make sure that the six connections are correct, or the entire multi-channel surround effects are disordered. The prior art wired headphone can achieve the multi-channel surround effect, but the connections are complex and the user is confined due to the length of wires.

In the prior art, some wireless headphones also provide the stereo surround effect and are more convenient than wired headphones. For example, U.S. Pat. No. 6,614,912 discloses an infrared-ray wireless headphone using two speakers to simulate the multi-channel effects. The principle is to transform multi-channel signals into left/right channel signals, and then wirelessly send the transformed signals to the headphone. However, the sound effect simulation using two speakers cannot perform perfect stereo surround effects. Furthermore, the transmission coverage of infrared-ray is small and infrared-rays cannot travel through objects. Hence, the user is confined to the room where the signal source is.

The following is transmission data rate for AC3 and DTS:

Dolby Digital (AC 3): 384˜448 kb/s

DTS: average ˜1500 kb/s

MPEG 2 Layer II: 640 kb/s

MPEG 2 AAC: 320 kb/s

As known in the prior art, the wireless transmission data rate for Bluetooth is 723 kb/s, not conforming (not fast enough) to all the above specifications. Analog transmissions (such as FM, AM) do not conform to SPDIF. Moreover, a specification of a signal delay time among each channel for AC3 is strict. For instance, the signal delay time between the rear channels and front channels depends on the distance from each speaker to the user, and should be within 10 ms. If the signal delay time does not conform to the specification, or the wireless transmission is not transmitted in real time, the Dolby multi-channel surround effects are not achieved.

Take WLAN for example. The wireless transmission data rate for WLAN conforms to the specifications. However, if the transmission is disturbed leading to errors in packets, the solution is to re-transmit the packets. The solution is feasible for general data but not audio signals. This would cause the stereo surround effect to be discontinuous. Take Bluetooth 1.1 for example, most signal delay time does not conform to AC3. From the above discussion, a digital wireless multi-channel audio system, equipped with a wireless transmitter of low signal delay time (less than 2 ms) and high transmission data rate (2000 kb/s), is needed to simultaneously send multi-channel signals to a wireless headphone having multiple speakers, such that the wireless headphone can provide the real multi-channel surround effects.

### SUMMARY OF INVENTION

It is therefore a primary objective of the claimed invention to provide a wireless multi-channel audio system to solve the above-mentioned problems.

The claimed invention discloses a wireless multi-channel audio system. The system includes a receiving unit, a decoder, a sound channel mixing and processing unit, and a plurality of speakers. The receiving unit receives and demodulates a wireless audio signal. The decoder is electrically connected to the receiving unit and decodes the demodulated audio signal into a plurality of multi-channel signals. The sound channel mixing and processing unit mixes and processes the multi-channel signals to generate a plurality of mixing signals for different stereo effects. The plurality of speakers output sounds according to the mixing signals.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 to FIG. 6 are diagrams of a wireless multi-channel headphone system according to the present invention.

FIG. 7 is a diagram of a wireless multi-channel audio system according to the present invention.

FIG. 8 is a diagram of a wireless transmitter according to the present invention.

FIG. 9 is a diagram of a wireless receiver according to the present invention.

### DETAILED DESCRIPTION

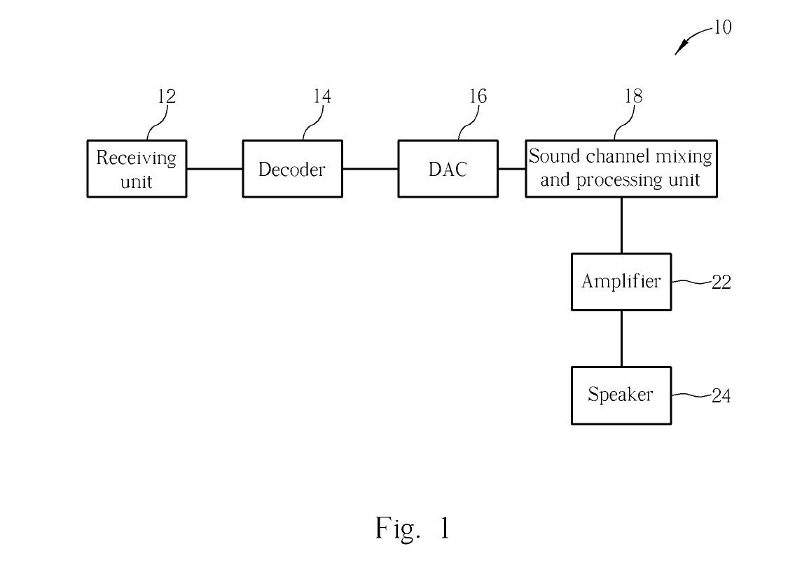

Please refer to FIG. 1, which is a diagram of an analog-output, wireless multi-channel headphone system 10. The wireless multi-channel headphone system 10 includes a receiving unit 12, a decoder 14, a digital-to-analog converter (DAC) 16, a sound channel mixing and processing unit 18, an amplifier 22, and a speaker 24. The receiving unit 12 receives and demodulates a wireless signal having multi-channel signals or conforming to Sony/Philips digital interface format (SPDIF). After that, the decoder 14 decodes each channel signal and transmits each decoded signal to the DAC 16. In the embodiment of FIG. 1, each decoded channel signal is mixed and processed in analog manner. The DAC 16 transforms the decoded digital signals into analog signals and then the analog signals are transmitted to the sound channel mixing and processing unit 18. The signals processed by the sound channel mixing and processing unit 18 are inputted into the amplifier 22 to drive the speaker 24. The speaker 24 outputs sounds according to the signals outputted from the amplifier 22.

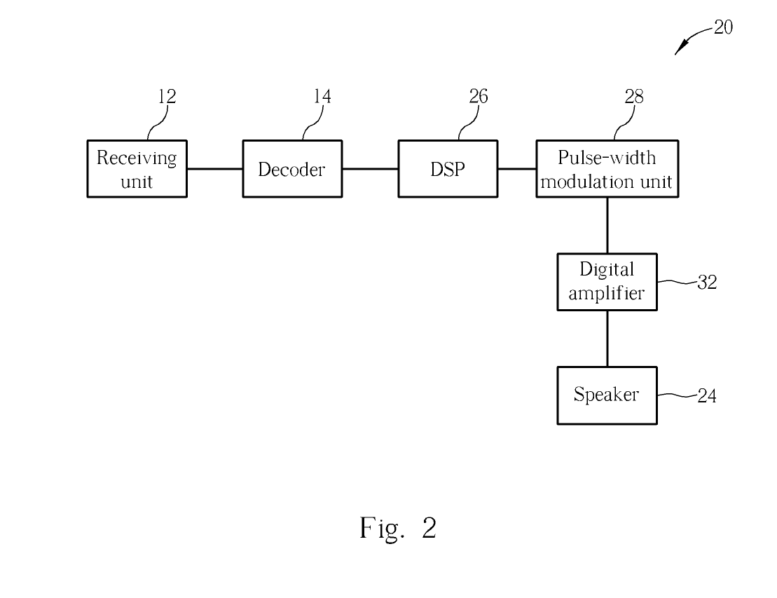

Please refer to FIG. 2, which is a diagram of an all-digital wireless multi-channel headphone system 20 according to the present invention. The wireless multi-channel headphone system 20 is a digital example of the present invention. The wireless multi-channel headphone system 20 comprises a receiving unit 12, a decoder 14, a digital signal processor (DSP) 26, a pulse-width modulation (PWM) unit 28, a digital amplifier 32, and a speaker 24. The function of the wireless multi-channel headphone system 20 of FIG. 2 is similar to that of the wireless multi-channel headphone system 10 of FIG. 1. In FIG. 1, the digital signals are transformed into the analog signals after the multi-channel signals are decoded. After that, the signals are processed and amplified in analog manner. However, the signals of FIG. 2 are all processed digitally. The receiving unit 12 receives and demodulates a wireless signal having multi-channel signals or conforming to SPDIF. The decoder 14 decodes each channel signal and outputs the signals to the DSP 26 to provide a variety of stereo effects. The PWM unit 28 and the digital amplifier 32 are used to amplify the signals to drive the speaker 24. Finally, the speaker outputs Dolby surround sounds based on each channel signal.

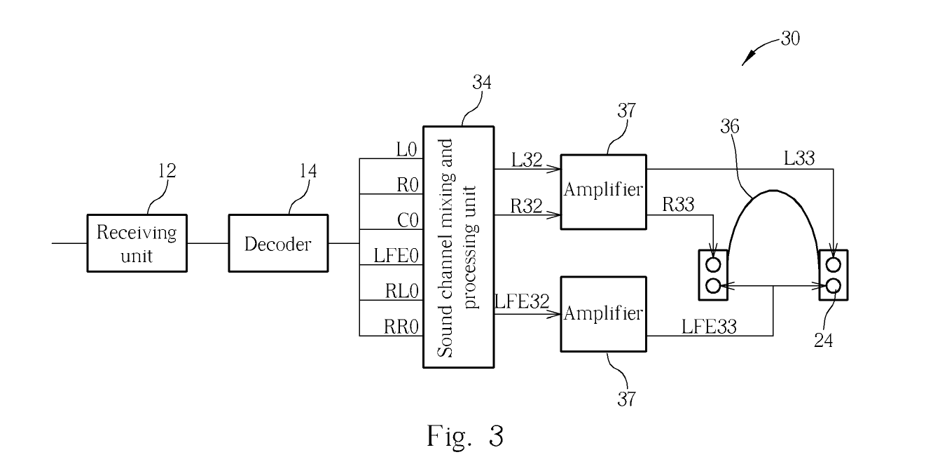

Please refer to FIG. 3, which is a diagram of a wireless multi-channel headphone system 30 according to the present invention. The wireless multi-channel headphone system 30 comprises a receiving unit 12, a decoder 14, a sound channel mixing and processing unit 34, an amplifier 37, a headphone 36, and four speakers 24. The receiving unit 12 and the decoder 14 perform the same function mentioned above to decode six-channel audio signals for Dolby Digital effect. The six-channel audio signals are a left channel signal L0, a right channel signal R0, a center channel signal C0, a low frequency effect signal LFE0, a rear-left channel signal RL0, and a rear-right channel signal RR0. The sound channel mixing and processing unit 34 combines, composes, or mixes different channel signals in a digital or analog manner, and outputs such signals to the amplifier 37. As shown in FIG. 3, the six-channel signals are transformed into a left channel signal L32, a right channel signal R32, and a low frequency effect signal LFE32. The signals L32 and R32 are derived from the five signals, L0, R0, C0, RL0, and RR0. The signal R32 is amplified and transformed into the signal R33 and then transmitted to the headphone 36 to drive a speaker 24 in the right side. The signal L32 is amplified and transformed into the signal L33 and then transmitted to the headphone 36 to drive a speaker 24 in the left side. The signal LFE32 is amplified and transformed into the signal LFE33 and then transmitted to the headphone 36 to drive two low frequency effect speakers 24 in the left and right side, respectively. After the user receives sounds outputted from the four speakers 24 according to different channel signals, the user can experience multi-channel surround effects.

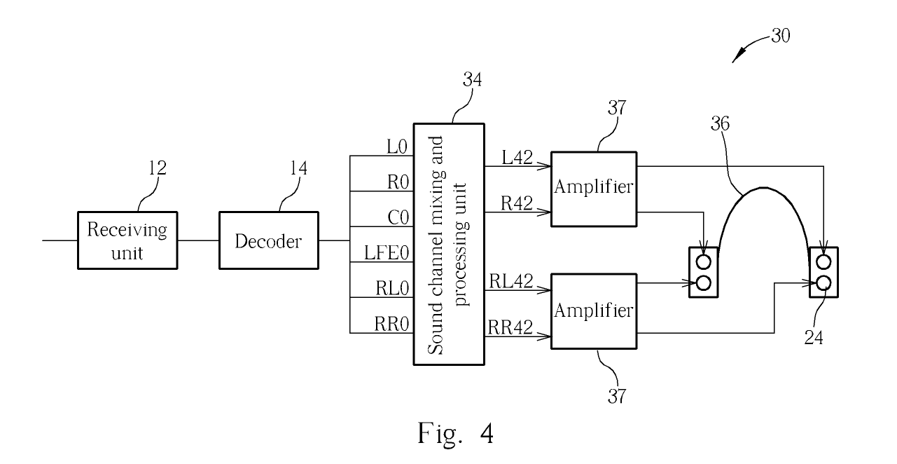

Please refer to FIG. 4, which is a diagram of a wireless multi-channel headphone system 30 according to the present invention. The operation of the embodiment of FIG. 4 is similar to that of the embodiment of FIG. 3. As shown in FIG. 4, the six-channel signals are combined and processed into four audio signals: a left channel signal L42, a right channel signal R42, a rear-left channel signal RL42, and a rear-right channel signal RR42. For instance, the signal L42 is a mixture of the signals L0 and C0. The signal R42 comprises R0 and C0. The signal RR42 is derived from the mixture of RR0 and LFE0 while the signal RL42 is derived from the mixture of RL0 and LFE0. The signals L42 and RL42 are amplified and simultaneously transmitted to the headphone 36 to drive the speakers 24 in the left side. In the same way, the signals R42 and RR42 are amplified and simultaneously transmitted to the headphone 36 to drive the speakers 24 in the right side.

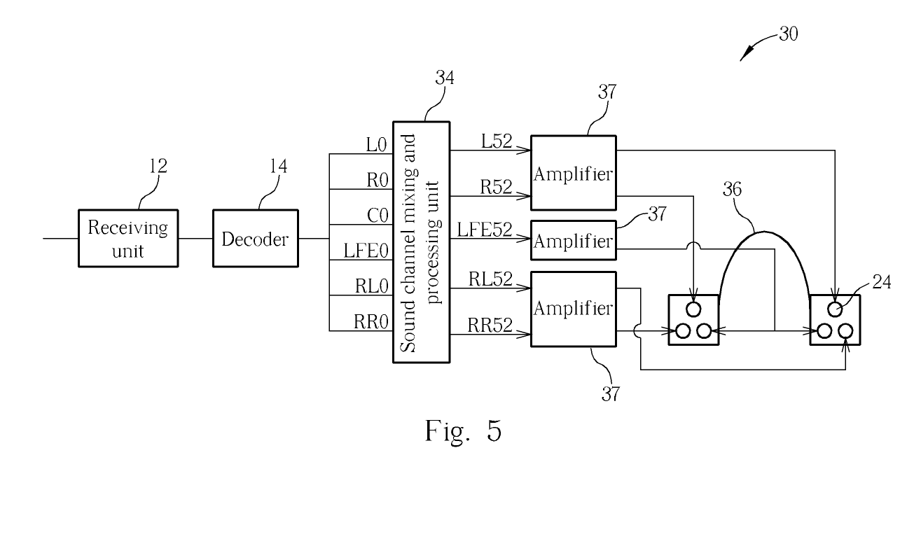

Please refer to FIG. 5, which is a diagram of another wireless multi-channel headphone system 30 according to the present invention. The embodiment of FIG. 5 is similar to that of FIG. 4. The six-channel audio signals L0, R0, C0, LFE0, RL0, and RR0, outputted from the decoder 14 are transformed into the signals L52 and RL52 transmitted to the speakers 24 in the left side, the signals R52 and RR52 transmitted to the speakers 24 in the right side, and the low frequency effect signal LFE52. As shown in FIG. 5, the five signals are transmitted to the speakers 24 of the headphone 36 to provide stereo effects.

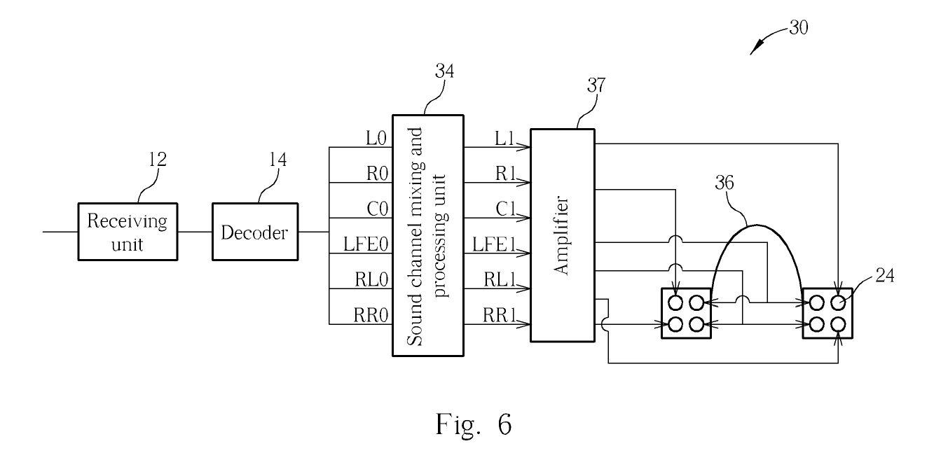

Please refer to FIG. 6, which is a diagram of a wireless multi-channel headphone system 30 according to the present invention. In this case, the six-channel audio signals L0, R0, C0, LFE0, RL0, and RR0 outputted from the decoder 14 are not mixed. The sound channel mixing and processing unit 34 performs a digital-to-analog transformation or a digital signal process to produce the input signals of the amplifier 37 for stereo effects. There are four speakers 24 in each side of the headphone 36. The four speakers 24 in the left side respectively output sounds based on the left channel signal, the rear-left channel signal, the center channel signal, and the low frequency effect signal. The four speakers 24 in the right side respectively output sounds based on the right channel signal, the rear-right channel signal, the center channel signal, and the low frequency effect signal.

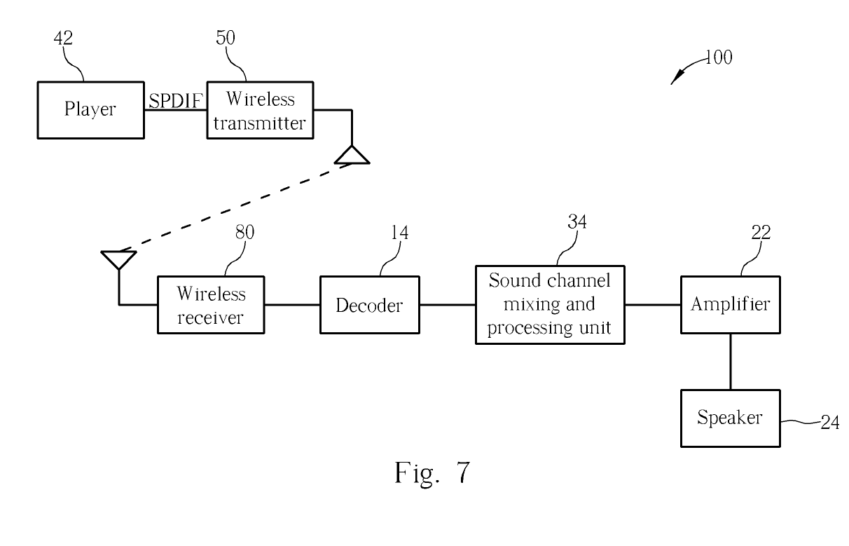

Please refer to FIG. 7, which is a diagram of a wireless multi-channel audio system 100 according to the present invention. The audio system 100 comprises a multi-channel player 42, such as a DVD player, a wireless transmitter 50, a wireless receiver 80, a decoder 14, a sound channel mixing and processing unit 34, an amplifier 22, and a speaker 24. The operations of the decoder 14, the sound channel mixing and processing unit 34, an amplifier 22, and a speaker 24 are similar to those mentioned above. Due to a limitation of transmission data rate for audio code-3 (AC3) or digital theater system (DTS), and a rule of delay time for converting signals among each channel for AC3 specification, a conventional transmitter cannot transmit signals correctly and thereby the purposes of playing audio in real time and Dolby multi-channel effects are not achieved. The wireless transmitter 50 and the wireless receiver 80 of the present invention have properties of a low signal delay time (less than 2 ms) and a high transmission data rate (2000 kb/s) to modulate, transmit, receive, and demodulate a wireless signal formatted for SPDIF in real time. After a signal is transmitted from the player 42 to the wireless transmitter 50 through a cable, the wireless transmitter 50 transforms the signal into a wireless signal. The wireless receiver 80 simultaneously receives and demodulates the SPDIF signal sent by the wireless transmitter 50, and then the signal is passed to the decoder 14 for other processes.

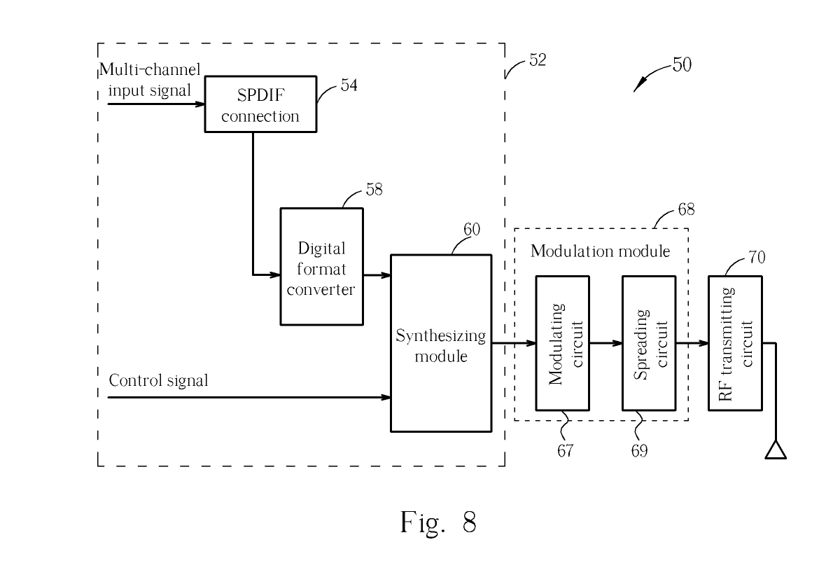

Please refer to FIG. 8, which is a diagram of the wireless transmitter 50. The wireless transmitter 50 comprises a media access controller (MAC) 52 for audio and data, a modulation module 68, and a radio frequency (RF) transmitting circuit 70. The media access controller 52 includes a digital format converter 58, a synthesizing module 60, and an SPDIF connection 54, such as an optical fiber connection or a coaxial cable connection. The media access controller 52 receives multi-channel input signals for different formats, such as AC3 or DTS. The digital format converter 58 electrically connected to the SPDIF connection 54 transforms the digital audio signal outputted from the SPDIF connection 54 into a pulse code modulation (PCM) signal. Finally, the synthesizing module 60 connected to the digital format converter 58 transforms a control signal and the PCM signal into a bit-stream signal. The modulation module 68 electrically connected to the synthesizing module 60 modulates the bit-stream signal to a corresponding base-band signal. The modulation module 68 includes a modulating circuit 67 and a spreading circuit 69. The modulating circuit 67 can be a π/4-differential quadrature phase shift keying (DQPSK) circuit for modulating the bit-stream signal outputted from the synthesizing module 60 to generate a modulated signal. The spreading circuit 69 electrically connected to the modulating circuit 67 utilizes the modulated signal and a spread-spectrum code to perform a convolution multiplication. That is, every bit of the modulated signal is replaced with a plurality of bits to generate the base-band signal. The base-band signal is transformed into an RF signal with high frequency by the RF transmitting circuit 70 and then wirelessly transmitted through the air.

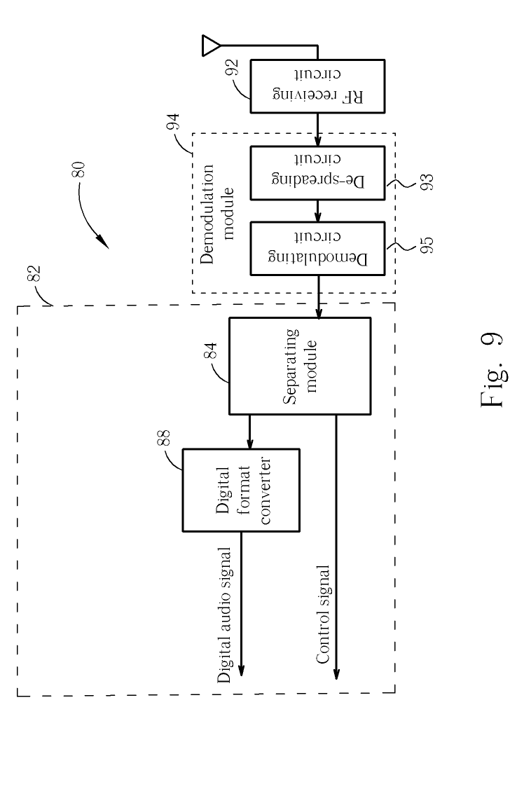

Please refer to FIG. 9, which is a diagram of the wireless receiver 80. The wireless receiver 80 comprises a media access controller (MAC) 82 for audio and data, a demodulation module 94, and a radio frequency (RF) receiving circuit 92. The media access controller 82 includes a separating module 84 and a digital format converter 88. The separating module 84 separates the bit-stream signal into a control signal and a PCM signal. The digital format converter 88 electrically connected to the separating module 84 transforms the PCM signal into a digital audio signal. The format of the digital signal outputted from the media access controller 82 conforms to SPDIF or I2S format. The media access controller 82 of the present invention also outputs a control signal to control the audio signal, as shown in FIG. 9.

The RF receiving circuit 92 receives an RF signal and generates a corresponding base-band signal. The demodulation module 94 electrically connected to the RF receiving circuit 92 performs an anti-operation of the modulation module 68; that is, the demodulation module 94 demodulates the base-band signal into the bit-stream signal of FIG. 8. How the demodulation module 94 demodulates signals is described as follows. The demodulation module 94 includes a de-spreading circuit 93 and a demodulating circuit 95. The de-spreading circuit 93 utilizes the base-band signal and a spread-spectrum code to perform a convolution multiplication to transform the base-band signal into a de-spreading signal. The demodulating circuit 95 demodulates the de-spreading signal in π/4-DQPSK manner to generate the bit-stream signal. Finally, the wireless receiver 80 sends the SPDIF signal to the decoder 14 of FIG. 7.

In the prior art, signals are transmitted to a multi-channel headphone through cables. Although the prior art can transmit SPDIF signals conforming to the multi-channel specification, the connection is complicated. This makes it inconvenient for the user to move around due to the length of cables. However, the present invention provides the user with the convenience of a wireless headphone. Another prior art of infrared-ray wireless headphone communicates the headphone with the player wirelessly. However, the transmission distance is very short and the infrared-ray cannot travel through objects. In addition, the infrared-ray wireless headphone utilizes two speakers to simulate multi-channel effects far from the real multi-channel effects. Moreover, Bluetooth transmission or analog transmission (such as FM, AM) cannot completely support SPDIF format. Although the wireless transmission data rate of WLAN is very high, it cannot transmit a complete SPDIF signal to the headphone having multiple speakers in real time and thereby the real multi-channel effect is not achieved. Compared with the prior art, the wireless multi-channel audio system of the present invention is capable of simultaneously transmitting and receiving signals formatted for SPDIF. The decoder and the sound channel mixing and processing unit of the present invention send SPDIF signals to the wireless headphone having multiple speakers wirelessly. Therefore, the wireless headphone of the present invention can achieve real multi-channel effects with high-end and high quality for AC3 or DTS.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wireless multi-channel audio system comprising:
a receiving unit for receiving and demodulating a wireless audio signal;
a decoder electrically connected to the receiving unit for decoding the audio signal into a plurality of multi-channel signals;
a sound channel mixing and processing unit for mixing and processing the multi-channel signals to generate a plurality of mixing signals conforming to different stereo and surround effects; and
a plurality of speakers for outputting sounds according to the mixing signals.

2. The wireless multi-channel audio system of claim 1 wherein the wireless audio signal conforms to Sony/Philips digital interface format (SPDIF).

3. The wireless multi-channel audio system of claim 1 wherein the plurality of speakers comprises six speakers conforming to Dolby Digital 5.1, the decoder decodes the wireless audio signal into six-channel signals, and the six speakers output sounds based on the six-channel signals.

4. The wireless multi-channel audio system of claim 3 wherein the sound channel mixing and processing unit mixes and processes two or more than two channel signals conforming to Dolby Digital 5.1.

5. The wireless multi-channel audio system of claim 1 further comprising a digital-to-analog converter (DAC) for transforming the multi-channel signals decoded by the decoder from digital signals into analog signals.

6. The wireless multi-channel audio system of claim 1 further comprising an amplifier for amplifying the audio signal to drive the speakers.

7. The wireless multi-channel audio system of claim 5 wherein the sound channel mixing and processing unit is an analog sound channel mixing and processing unit to mix and process analog multi-channel signals.

8. The wireless multi-channel audio system of claim 5 wherein the sound channel mixing and processing unit is a digital signal processor (DSP) to mix and process digital multi-channel signals.

9. The wireless multi-channel audio system of claim 1 further comprising a wireless transmitter for modulating the audio signals formatted for SPDIF and then transforming the modulated signals into radio frequency (RF) signals.

10. The wireless multi-channel audio system of claim 9 further comprising a wireless receiver for simultaneously receiving the RF signals of the wireless transmitter and demodulating the received signals into signals formatted for SPDIF.

11. The wireless multi-channel audio system of claim 9 wherein the wireless transmitter comprises:
a digital multi-channel signal connection for receiving the multi-channel input signal;
a digital format converter electrically connected to the digital multi-channel signal connection for transforming the digital multi-channel signal into a pulse code modulation (PCM) signal; and
a synthesizing module electrically connected to the digital format converter for synthesizing a control signal and the PCM signal into a bit-stream signal.

12. The wireless multi-channel audio system of claim 11 wherein the wireless transmitter further comprises a modulation module electrically connected to the synthesizing module for modulating the bit-stream signal to generate a corresponding base-band signal.

13. The wireless multi-channel audio system of claim 12 wherein the modulation module comprises:
a modulating circuit electrically connected to the synthesizing module for modulating the bit-stream signal to generate a modulated signal; and
a spreading circuit electrically connected to the modulating circuit for generating the base-band signal by using the modulated signal and a spread-spectrum code.

14. The wireless multi-channel audio system of claim 12 wherein the wireless transmitter further comprises a transmitting circuit electrically connected to the modulation module for transforming the base-band signal into a radio frequency (RF) signal and then sending the RF signal through the air.

15. The wireless multi-channel audio system of claim 10 wherein the wireless receiver comprises:
a receiving circuit for receiving the RF signal to generate a corresponding base-band signal;
a demodulation module electrically connected to the receiving circuit for demodulating the base-band signal into a bit-stream signal;
a separating module electrically connected to the demodulation module for separating the bit-stream signal into a control signal and a pulse code modulation (PCM) signal; and
a digital format converter electrically connected to the separating module for transforming the PCM signal into a digital audio signal.

16. The wireless multi-channel audio system of claim 15 wherein the demodulation module comprises a de-spreading circuit and a demodulating circuit, wherein the de-spreading circuit uses the base-band signal and a spread-spectrum code to perform a convolution multiplication to transform the base-band signal into a de-spreading signal, and the demodulating circuit demodulates the de-spreading signal to generate the bit-stream signal.

17. A wireless multi-channel audio system comprising:
a receiving unit for receiving and demodulating a wireless audio signal formatted for Sony/Philips digital interface format (SPDIF); and
a decoder electrically connected to the receiving unit for decoding the audio signal into a plurality of multi-channel signals.

18. The wireless multi-channel audio system of claim 17 further comprising a sound channel mixing and processing unit for mixing and processing the multi-channel signals to generate a plurality of mixing signals for different stereo surround effects.

19. The wireless multi-channel audio system of claim 18 further comprising a plurality of speakers for outputting sounds according to the mixing signals or the multi-channel signals.

20. The wireless multi-channel audio system of claim 17 further comprising six speakers conforming to Dolby Digital 5.1, the decoder decoding the wireless audio signal into six-channel signals, and the six speakers outputting sounds based on the six-channel signals.

21. The wireless multi-channel audio system of claim 18 wherein the sound channel mixing and processing unit mixes and processes two or more than two channel signals conforming to Dolby Digital 5.1.

22. The wireless multi-channel audio system of claim 17 further comprising a digital-to-analog converter (DAC) for transforming the multi-channel signals decoded by the decoder from digital signals into analog signals.

23. The wireless multi-channel audio system of claim 18 further comprising an amplifier for amplifying the audio signal to drive the speakers.

24. The wireless multi-channel audio system of claim 18 wherein the sound channel mixing and processing unit is an analog sound channel mixing and processing unit to mix and process analog multi-channel signals.

25. The wireless multi-channel audio system of claim 18 wherein the sound channel mixing and processing unit is a digital signal processor (DSP) to mix and process digital multi-channel signals.

26. The wireless multi-channel audio system of claim 17 further comprising a wireless transmitter for modulating the audio signals formatted for SPDIF and then transforming the modulated signals into radio frequency (RF) signals.

27. The wireless multi-channel audio system of claim 26 further a wireless receiver for simultaneously receiving the RF signals of the wireless transmitter and demodulating the received signals into signals formatted for SPDIF.

28. The wireless multi-channel audio system of claim 26 wherein the wireless transmitter comprises:
a digital multi-channel signal connection for receiving the multi-channel input signal;
a digital format converter electrically connected to the digital multi-channel signal connection for transforming the digital multi-channel signal into a pulse code modulation (PCM) signal; and
a synthesizing module electrically connected to the digital format converter for synthesizing a control signal and the PCM signal into a bit-stream signal.

29. The wireless multi-channel audio system of claim 28 wherein the wireless transmitter further comprises a modulation module electrically connected to the synthesizing module for modulating the bit-stream signal to generate a corresponding base-band signal.

30. The wireless multi-channel audio system of claim 29 wherein the modulation module comprises:
a modulating circuit electrically connected to the synthesizing module for modulating the bit-stream signal to generate a modulated signal; and
a spreading circuit electrically connected to the modulating circuit for generating the base-band signal by using the modulated signal and a spread-spectrum code.

31. The wireless multi-channel audio system of claim 29 wherein the wireless transmitter further comprises a transmitting circuit electrically connected to the modulation module for transforming the base-band signal into a radio frequency (RF) signal and then sending the RF signal through the air.

32. The wireless multi-channel audio system of claim 27 wherein the wireless receiver comprises:
a receiving circuit for receiving the RF signal to generate a corresponding base-band signal;
a demodulation module electrically connected to the receiving circuit for demodulating the base-band signal into a bit-stream signal;
a separating module electrically connected to the demodulation module for separating the bit-stream signal into a control signal and a pulse code modulation (PCM) signal; and
a digital format converter electrically connected to the separating module for transforming the PCM signal into a digital audio signal.

33. The wireless multi-channel audio system of claim 32 wherein the demodulation module comprises a de-spreading circuit and a demodulating circuit, wherein the de-spreading circuit uses the base-band signal and a spread-spectrum code to perform a convolution multiplication to transform the base-band signal into a de-spreading signal, and the demodulating circuit demodulates the de-spreading signal to generate the bit-stream signal.
